(19) United States
(12) Patent Application Publication
(10) Pub. No.: US 2022/0259459 A1
(43) Pub. Date: Aug. 18, 2022

(54) METHOD FOR ENHANCING BONDING SURFACE OF DIFFICULT TO BOND PLASTICS

(71) Applicant: Illinois Tool Works Inc., Glenview, IL (US)

(72) Inventors: Maxwell VanRaaphorst, Glenview, IL (US); Colin Peter Senechal, JR., Glenview, IL (US); Liam Adams Williams, Glenview, IL (US); Mathew J. Masini, Glenview, IL (US); Peter A. Carbutt, Glenview, IL (US)

(73) Assignee: Illinois Tool Works Inc., Glenview, IL (US)

(21) Appl. No.: 17/673,129

(22) Filed: Feb. 16, 2022

Related U.S. Application Data
(60) Provisional application No. 63/150,740, filed on Feb. 18, 2021.

(51) Int. Cl. C09J 5/02; C09J 7/50; B32B 37/12; B32B 37/18; B32B 15/08; B32B 7/12

(52) U.S. Cl. CPC C09J 5/02; C09J 7/50; B32B 37/1284; B32B 37/182; B32B 15/08; B32B 2264/102; C09J 2400/166; C09J 2301/504; C09J 2203/354; B32B 2255/10; B32B 2255/20; B32B 7/12

(57) ABSTRACT

A method of bonding includes providing a thermoplastic substrate having a surface with a surface energy value of less than a 48 miliJoules per meter squared. The surface is exposed to particulate formed in a combustion flame from a precursor. The particulate forms an adherent layer of metal oxide on the surface. An adhesive is applied to the adherent layer. A second substance is placed in in simultaneous contact with the adhesive to bond the thermoplastic. A laminate is provided that includes a thermoplastic substrate having a surface. An adherent layer of metal oxide is on a surface of the thermoplastic substrate. An adhesive is attached to the adherent layer. A second substance is in simultaneous contact with the adhesive.

### RELATED APPLICATIONS

This application claims priority benefit of U.S. Provisional Application Ser. No. 63/150,740 filed Feb. 18, 2021; the contents of which are hereby incorporated by reference.

### FIELD OF THE INVENTION

The present invention in general relates to surface treatments, and in particular to a plastic surface treatment amenable to adhesive bonding.

### BACKGROUND OF THE INVENTION

The ability to adhesively bond to a surface with a limited number of available bonding sites and characterized by a surface energy value of less than approximately 48 miliJoules per meter squared (mJ/m²) has been addressed in the past through surface activation of the low energy surface through various treatments such as exposure to flame, plasma, ion bombardment, or other processes to create reactive moieties to which an adhesive could bond. While such low energy surface modification treatments proved effective, they have met with limited acceptance owing to the cost, limited duration of surface activation, and the impracticality of surface treatment in field usage or to bond large area substrates.

Resort to primer compositions intermediate between a low energy surface and an adhesive were found to address in part the limitations of high energy surface treatments, yet such primers add to the cost and complexity of bonding thereby limiting instances of practical usage. Additionally, the strength of low energy surfaces adhesively bonded through resort to primers has compromised strength owing to interfacial delamination.

Despite the numerous advantages of structural adhesives over the more traditional mechanical methods of joining, such as by clamps, nuts and bolts, etc., one of the most important reasons these aforementioned adhesives have not made more sizable inroads into industrial bonding applications.

Thus, there exists a need for an enhanced low surface energy bonding treatment to traditional adhesives such as two or one part urethanes, two part methyl methacrylate, and acrylic adhesives and without resort to conventional adhesion promotors or aggressive plasma treatments.

### SUMMARY OF THE INVENTION

A method of bonding includes providing a thermoplastic substrate having a surface with a surface energy value of less than a 48 miliJoules per meter squared. The surface is exposed to particulate formed in a combustion flame from a precursor. The particulate forms an adherent layer of metal oxide on the surface. An adhesive is applied to the adherent layer. A second substance is placed in in simultaneous contact with the adhesive to bond the thermoplastic.

A laminate is provided that includes a thermoplastic substrate having a surface with a surface energy value of less than a 48 miliJoules per meter squared. An adherent layer of metal oxide is on a surface of the thermoplastic substrate. An adhesive is attached to the adherent layer. A second substance is in simultaneous contact with the adhesive.

### BRIEF DESCRIPTION OF THE DRAWINGS

The present invention is further detailed with respect to the following drawings that are intended to show certain aspects of the present invention but should not be construed as a limit on the practice of the present invention. The relative dimensions of layers are distorted with visual clarity.

FIG. 1 is a schematic of an inventive method for formation of adherent layer of metal oxide on a surface of the substrate; and

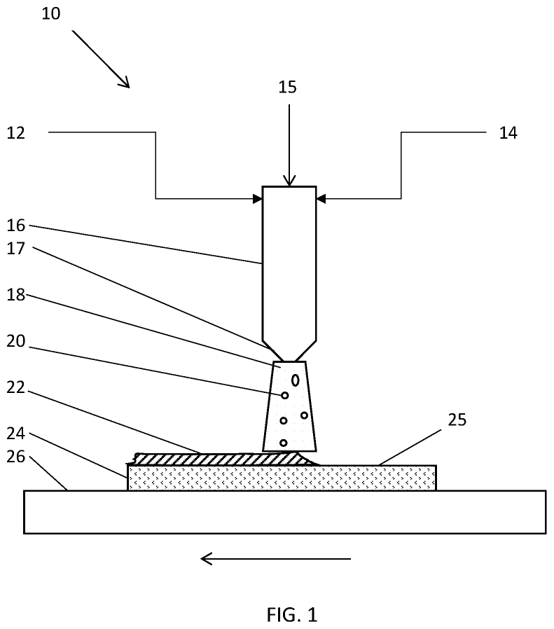

FIG. 2 is a cross sectional view of an inventive laminate.

### DETAILED DESCRIPTION OF THE INVENTION

The present invention has utility as a method of forming a layer of metal oxide on low surface energy thermoplastic target substrate. Unlike conventional techniques that apply such layers under reduced pressure, using complex plasma, or under conditions that can deform or otherwise damage a thermoplastic substrate molded into a complex shape; the present invention efficiently applies an adherent layer of metal oxide on the thermoplastic surface to which an adhesive is directly applied. A second substance placed in in simultaneous contact with the adhesive is bonded to the thermoplastic.

Typical thermoplastic substrates are used in general industrial and transportation markets, where the use of such plastics for strength and light-weighting is desired. In particular here, the present invention allows for common metals, coated metal clips, or vehicle structure to be structurally bonded to the thermoplastic or to manufacture a given article from the thermoplastic. As a result, the present invention minimizes or eliminates the use of mechanical fasteners, vibration welding or other long processes or chemical treatment processes thereby reducing scrappage and manufacturing time.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below. As used in the description of the invention and the appended claims, the singular forms “a,” “an” and “the” are intended to include the plural forms as well, unless the context clearly indicates otherwise. Also as used herein, “and/or” refers to and encompasses any and all possible combinations of one or more of the associated listed items, as well as the lack of combinations when interpreted in the alternative (“or”).

As used herein, metal oxide is defined as a MOₓ where M is a cation of Ni, Si, B, Co, Fe, Cu, Al, Ga, or Sn, and x is an rational number of between 0.8-1.0 for +2 M oxidation states and 1.4 and 2.0 for +4M oxidation states. The metal oxide being amorphous or having crystalline domain sizes of from 1 to 200 nm as measured by Debye-Scherrer line broadening.

The present invention modifies a thermoplastic as a substrate having a surface energy value of less than a 48 miliJoules per meter squared. Thermoplastic substrates operative herein illustratively include polyethylene, polypropylene, polyethylene terephthalate, disparpolypropylenes, polyamides, polyesters, polyether ether ketones, polybenzobisoxazoles, polyphenylene sulfide, and block copolymers containing at least of one of the aforementioned constituting at least 40 percent by weight of the copolymer; and blends thereof.

The present invention affords a layer of metal oxide that is deposited by combustion chemical vapor deposition (C-CVD). A uniform flame nozzle is extendible over a linear extent of from 0.01 to 6 meters, or even more so as produce a layer of metal oxide with a controlled rate of deposition across the linear extent. The deposition is controlled to provide a uniformity of thickness across the linear extent or has varied combustions zones to create areas that are of greater or lesser thickness in a given region. The present invention applies a layer of metal oxide while the thermoplastic substrate is maintained at atmosphere pressure.

A schematic of an inventive system applying a layer of metal oxide is shown in general at 10. The system includes an inlet 12 for a combustible gas. A combustible gas operative herein illustratively includes a C₁-C₆ alkane, a C₂-C₆ alkene, ethylene oxide, and combinations thereof. A metal containing precursor inlet 14 is also delivered to gas burner 16. In some embodiments, an air or oxygen inlet 15 is also provided. The ratio of the combustible gas: metal containing precursor is readily adjusted to control the stoichiometry of metal:oxygen. Upon ignition of the gas mixture from the burner tip 17, a flame 18 is generated in which particles 20 of metal oxide and precursors thereof are formed. Parameters that control the composition and deposition rate includes: combustible flow rate, air flow rate, precursor flow rate, precursor concentration, distance between surface and burner tip, and translation rate of substrate stage. Typical operation conditions according to the present invention include Typical process conditions for layer formation include a burner air flow of 0.1 to 100 SLM, an air-to-combustible ratio of 1000:1 to 2:1, a burner tip to surface distance of between 1 and 300 mm, and a stage linear velocity of about 50 mm/sec, and a flame length of from 1 to 50 mm from the surface 26 of the substrate 22 to be coated.

The particulate 20 condenses to form a layer of metal oxide 22 adherent to a surface 25 of a substrate 24. While the surface 25 is depicted as planar, it is appreciated that the surface is also readily formed as in the shape of a planar curve, a complex three dimensional shape, or a combination thereof. A substrate stage 26 is depicted as translating from right to left to deposit a layer 22. It is appreciated that the stage 26 can move in various directions including vertical relative to the burner tip 17. In still other embodiments, the burner 16 is movable. In still other embodiments, the stage 26 includes a heating element or a cooling element to control the temperature of the substrate 24.

A typical thickness of a layer 22 is between 5 and 5000 nanometers (nm) and typical deposition to these thicknesses range from 5 to 300 seconds.

Precursors operative herein illustratively include hexamethyldisiloxane. tetraethoxysilane, tetraethylorthosilicate, silicon tetrachloride, nickel alkoxides, and combinations thereof. In some inventive embodiments, the precursor is volatile while in other instances, a solution of the precursor can be atomized/nebulized sufficiently, the atomized solution functions as gas and can he transferred to the flame without requiring an appreciable vapor pressure from the precursor.

Without intending to be bound to a particular theory, it is believed that the metal oxide layer has surface polar moieties of hydroxyl, carboxyl, and ylides, and lone pairs capable of forming covalent dative bonds. The surface polar moieties are amenable to reaction with an adhesive applied thereon. The nanostructure of the layer of metal oxide with an increased surface area relative the surface of the substrate also enhances bonding.

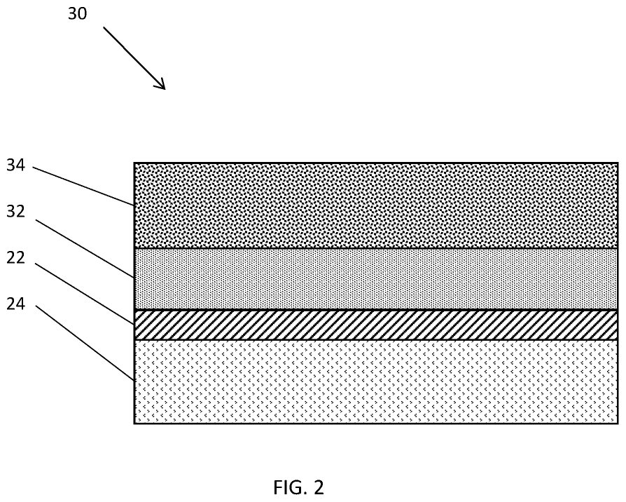

As shown in FIG. 2, adhesive 32 is applied onto the layer of metal oxide 22. Adhesives operative herein illustratively include two or one part urethanes, two-part methyl methacrylate, acrylic adhesives, mixtures thereof, and hybrids thereof, in some inventive embodiments, the adhesive 32 contains silane adhesion promoters or silane functional elements. Adhesion promoters operative herein illustratively include phosphate esters; phosphate ester polymers; mixtures of mono- and di-functional phosphates; functionalized methacrylates such as hydroxyethylmethacrylate succinate, acetoacetoxy ethyl methacrylate, N,N-diethylaminoethyl methacrylate, ethoxylated bisphenol A dimethacrylate and methacrylate silanes and combinations thereof. In still other embodiments, a silanizing agent modifies the substrate surface to achieve improved surface bonding of inventive composition compared to formulations lacking the same by modifying the hydrophobicity of the substrate surface.

The present invention is further detailed with respect to the following examples. These examples are illustrative of specific embodiments of the present invention and not intended to limit the scope of the appended claims.

As a person skilled in the art will recognize from the previous detailed description and from the figures and claims, modifications and changes can be made to the preferred embodiments of the invention without departing from the scope of this invention defined in the following claims.

1. A method of bonding a thermoplastic comprising:
providing a thermoplastic substrate having a surface with a surface energy value of less than a 48 miliJoules per meter squared;
exposing the surface to particulate formed in a flame from a precursor;
forming the particulate into an adherent layer of metal oxide on the surface;
applying an adhesive to the adherent layer; and
attaching a second substance in in simultaneous contact with said adhesive to bond the thermoplastic.

2. The method of claim 1, wherein the layer is SiOₓ.

3. The method of claim 2, wherein the precursor is hexamethyldisiloxane.

4. The method of claim 2, wherein the precursor is tetraethylorthosilicate or silicon tetrachloride.

5. The method of claim 1, wherein the layer is NiOₓ.

6. The method of claim 5, wherein the precursor is a nickel alkoxide.

7. The method of claim 1, wherein said adherent layer of metal oxide is substantially uniform.

8. The method of claim 1, further comprising a combustible gas.

9. The method of claim 8, wherein said combustible gas operative is one or more of a C₁-C₆ alkane, a C₂-C₆ alkene, ethylene oxide, or a combination thereof.

10. A laminate comprising:
a thermoplastic substrate:
an adherent layer of metal oxide on a surface of the thermoplastic substrate;
an adhesive to the adherent layer; and
a second substance in in simultaneous contact with said adhesive.

11. The laminate of claim 10, wherein said thermoplastic is one of: polyethylene, polypropylene, polyethylene terephthalate, disparpolypropylenes, polyamides, polyesters, polyether ether ketones, polybenzobisoxazoles, polyphenylene sulfide, or block copolymers containing at least of one of the aforementioned constituting at least 40 percent by weight of the copolymer; or blends thereof.

12. The laminate of claim 10, wherein said adherent layer of metal oxide is from 5 to 5000 nm in thickness.

13. The laminate of claim 10, wherein the layer is SiOₓ.

14. The laminate of claim 10, wherein said adhesive is at least one of: a two part urethane, a one part urethane, a two-part methyl methacrylate, an acrylic adhesive, mixtures thereof, and hybrids thereof.

15. The laminate of claim 10, wherein said adhesive further comprises an adhesion promotor.

16. The laminate of claim 15, wherein said adhesion promotor is one or more a phosphate ester, a phosphate ester polymer; a mixture of mono- and di-functional phosphates, a hydroxyethylmethacrylate succinate, an acetoacetoxy ethyl methacrylate, N,N-diethylaminoethyl methacrylate, ethoxylated bisphenol A dimethacrylate, a methacrylate silane, or a combination thereof.

17. The laminate of claim 10, wherein said second substance is a metal.

18. An automotive part formed from a laminate of claim 10.
